(19) United States
(12) Patent Application Publication
(10) Pub. No.: US 2016/0023745 A1
(43) Pub. Date: Jan. 28, 2016

(54) SEALING ASSEMBLY ON THE EXTERIOR OF AN AIRCRAFT

(71) Applicant: Airbus Operations GmbH, Hamburg (DE)

(72) Inventors: Memis Tiryaki, Hamburg (DE); Matthias Hegenbart, Hamburg (DE); Michael Sauer, Hamburg (DE)

(21) Appl. No.: 14/806,878

(22) Filed: Jul. 23, 2015

(30) Foreign Application Priority Data
Jul. 24, 2014 (DE) 102014110486.2

(51) Int. Cl. B64C 1/12; B64C 3/26

(52) U.S. Cl. CPC B64C 1/12; B64C 3/26

(57) ABSTRACT

A sealing assembly on an aircraft exterior having several sealing elements, lying one behind the other in the flight direction. The contact surfaces of the sealing elements sit on a bearing surface. The sealing elements are attached to seal retainer elements. The rear end of each sealing element lies immediately adjacent to the front end of the subsequent sealing element located further back on the aircraft. Adjacent sealing elements form a stepless contact surface and an essentially continuous top surface, interrupted only by the gaps between them. The front end of each rearward sealing element is mechanically coupled to the rear end of the adjacent forward sealing element in such a way that the gap lying between them is bridged. The front end of the sealing element located further to the rear is prevented from lifting relative to the rear end of the forward sealing element.

### CROSS-REFERENCES TO RELATED APPLICATIONS

This application claims the benefit of the German patent application No. 10 2014 110 486.2 filed on Jul. 24, 2014, the entire disclosures of which are incorporated herein by way of reference.

### BACKGROUND OF THE INVENTION

The invention relates to a sealing assembly on the exterior of an aircraft, which includes several sealing elements lying one behind the other in the direction of flight, the contact surfaces of which sit on a bearing surface, and which are attached to seal retainer elements, wherein the rear end of one sealing element lies immediately adjacent to the front end of the subsequent sealing element located further back on the aircraft in the direction of flight, and adjacent sealing elements form an essentially continuous top surface, interrupted by the gap between them, and a lower contact surface.

Such sealing assemblies are found, for example, on the fuselage fairing surrounding the fuselage end of the wing. The sealing elements, which are attached to the, in particular, plate-shaped seal retainer elements of the fuselage fairing and are made of a rubber-elastic material, sit with their contact surfaces on the outer surface of the wing which forms the bearing surface. In accordance with the design requirements, individual sealing elements are arranged next to one another and are separated from one another by narrow gaps.

One problem with such a sealing assembly is that the air flowing over the sealing elements during flight generates a vacuum which acts on the sealing elements, causing the front end of one sealing element to lift a little relative to the rear end of the sealing element lying in front of it in the direction of flight. The projecting edge of the rear sealing element formed by the lifting is struck by a portion of the airflow, so that the air can also flow under the rear sealing element. This can cause damage to the front end of the rear sealing element.

### SUMMARY OF THE INVENTION

An objective of the invention is to provide a sealing assembly designed such that the above-mentioned damages to the sealing elements are avoided.

In order to achieve this objective, a sealing assembly as described at the outset is designed according to the invention in such a way that the front end of the sealing element located further to the rear is mechanically coupled to the rear end of the sealing element lying in front of it in such a way that the gap lying between them is bridged and the front end of the sealing element located further to the rear is secured so that it will not lift relative to the rear end of the front sealing element.

With such a design, firstly an essentially stepless and thus streamlined surface is created on the top side of the sealing elements, and secondly, the front end of the rear sealing element is prevented from lifting during operation caused by the vacuum generated by the airflow in a way that would create a relief between the rear end of the front sealing element and the front end of the rear sealing element, which the airflow could strike and which could cause damages. Flow of air under the rear sealing element, which would cause said sealing element to lift further, is also prevented.

In order to realize the coupling of adjacent sealing elements, in one embodiment using the so-called “adapter concept,” an additional adapter element can be disposed in the gap between the adjacent sealing elements, which is attached to the seal retainer elements and engages with both sealing elements and, together with the undersides of the sealing elements, forms a contact surface.

In the process, the upper surface of the adapter element can form together with the upper surfaces of the adjacent sealing elements a preferably continuous, essentially stepless top surface wherein narrow gaps may form in said top surface when placed on a curved region of the bearing surface.

In one embodiment of this assembly, the adapter element can extend by means of projections under both sealing elements, and the projections are connected to the sealing elements, for example via an attachment system or by adhesive. In this way, the projections hold the adapter element in its position, working against the vacuum present during operation.

In order to achieve a particularly strong coupling between the sealing elements in such a configuration, the ends of the sealing elements adjoining the adapter element can be beveled and can extend into correspondingly designed recesses in the adapter element.

In another embodiment of the adapter element, it can have angled ends, which extend into correspondingly shaped recesses in the ends of the sealing elements, so that in this way a coupling is achieved which prevents a lifting of the front end of the rear sealing element relative to the rear end of the front sealing element.

In order to also improve the flow conditions in the area between adjacent seal retainer elements, the adapter element can include a projection extending between the seal retainer elements in the area of the seal retainer elements.

The coupling of adjacent sealing elements can also be achieved, in the case of the so-called “overlap concept,” in that the front end of the sealing element located further to the rear includes a projection overlapping the underside of the rear end of the front sealing element, which projection extends into a recess on the underside of the front sealing element, so that a stepless contact surface is formed.

This design secures the front end of the rear sealing element so that it will not lift relative to the rear end of the front sealing element, even when there is still a small gap between these ends.

This coupling can be further improved if the front end of the projection is designed with an engagement rib, which extends into a correspondingly shaped indentation in the front sealing element.

### BRIEF DESCRIPTION OF THE DRAWINGS

The invention is explained in greater detail below by reference to the figures showing schematic and greatly simplified exemplary embodiments.

FIG. 1 shows, in a simplified perspective representation, an aircraft in which the sealing assembly according to the invention can be employed.

FIG. 2 shows, partially in cross-section and partially as a projection, a portion of the sealing assembly on the aircraft according to FIG. 1.

FIG. 3 shows, in a schematic top view, a sealing assembly having an adapter element.

FIG. 4 shows a simplified cross-section along the line A-A of FIG. 3.

FIG. 5 shows, in a representation corresponding to FIG. 4, a sealing assembly having a differently designed adapter element.

FIG. 6 shows, in a representation similar to FIG. 5, a slightly differently designed adapter element.

FIG. 7 shows a sealing assembly having another adapter element form.

FIG. 8 shows, in a representation similar to FIG. 3, a different design of the sealing assembly.

FIG. 9 shows the sealing assembly of FIG. 8 in a view which corresponds to that of FIG. 7.

FIG. 10 shows a further development of the sealing assembly according to FIGS. 8 and 9.

FIG. 11 shows an attachment system for use in the sealing assembly.

### DETAILED DESCRIPTION OF THE PREFERRED EMBODIMENTS

In one exemplary embodiment, the sealing assembly according to the invention can be mounted on an aircraft in the area between the fuselage and the wing, as described below with reference to FIG. 1. The invention is, however, by no means limited to an application in this location, and it can also be employed in other locations on an aircraft.

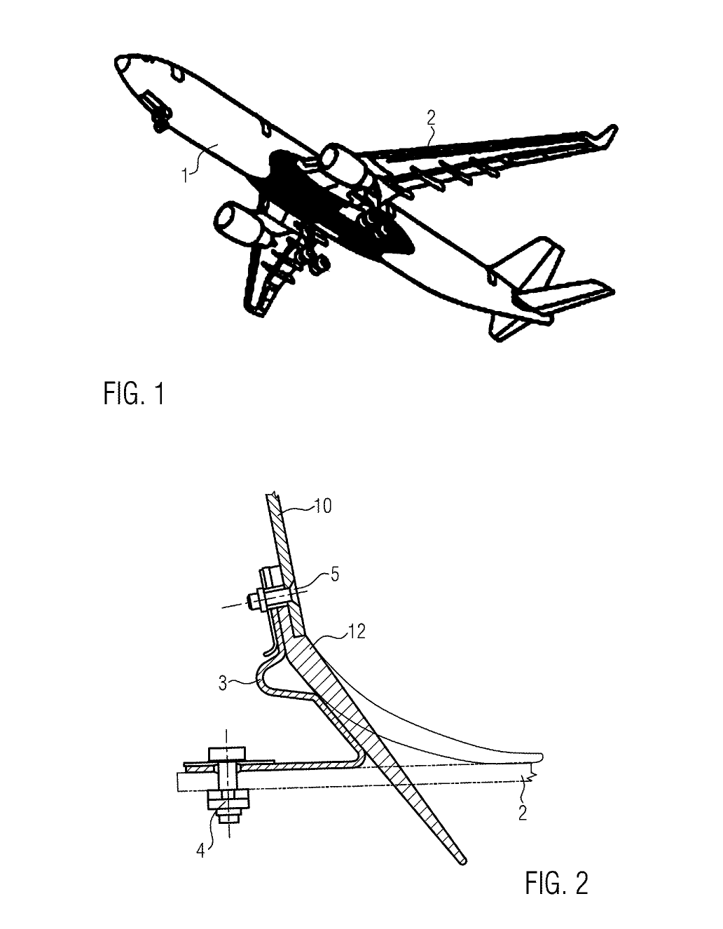

The aircraft according to FIG. 1 has, between fuselage 1 and wing 2, a fuselage fairing attached to the fuselage 1 and surrounding the wing, which fuselage fairing is made up of individual, in this case plate-shaped, seal retainer elements (10 in FIG. 2), which in the example shown here are attached via screws to a coupling profile 3. The coupling profile is attached via screws 4 to the wing 2. A sealing element (12 in FIG. 2) made of rubber-elastic material is held and secured by means of the attachment screws 5 between the coupling profile 3 and the seal retainer elements, in each case. In FIG. 2, the sealing element 12 is shown as a hatch-line representation in the unstressed state. In addition, the shape of the sealing element, when it sits on the broken-line indicated surface of the wing 2, is shown.

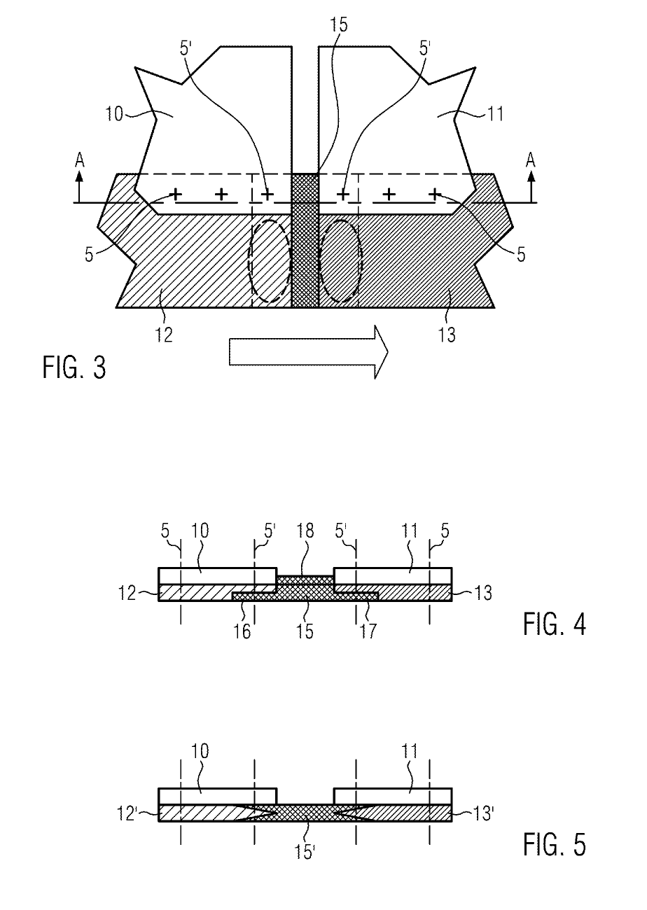

In accordance with the design requirements, individual sealing elements are arranged next to and in close proximity to one another, and of these, the sealing elements 12 and 13 are schematically represented in FIGS. 3 and 4. The sealing element 12 is attached via screws 5, 5′ to the plate 10 of the fuselage fairing and the sealing element 13, via screws 5, 5′, to the plate 11 of the fuselage fairing. As indicated by the arrow symbolizing the flow direction in FIG. 3, the sealing element 12 constitutes the front element in the direction of flow, and the sealing element 13 constitutes the rear element in the direction of flow. In the “adapter concept” depicted here, an adapter element 15 made of rubber-elastic material is provided between these elements, which forms, together with the upper surfaces of the sealing elements 12 and 13, a continuous, stepless top surface, as depicted, while a projection 18 formed on its upper surface extends between the seal retainer elements 10 and 11 and thus improves the flow behavior between the adjacent seal retainer elements.

Projections 16, 17 are provided on the underside of the adapter element 15, which extend into recesses on the undersides of the sealing elements 12 and 13 and which are attached by means of attachment systems to the sealing elements 12 and 13, the attachment systems being provided in the areas identified by broken-line ovals in FIG. 3 and explained in detail by reference to FIG. 11.

The underside of the adapter element 15, together with the projections 16 and 17, forms a stepless, continuous surface with the undersides of the sealing elements 12 and 13. The attachment systems prevent the sealing elements 12, 13 from lifting away from the adapter element 15.

The embodiment shown in FIG. 5, which likewise employs the “adapter concept,” includes sealing elements 12′ and 13′, the ends of which facing one another are beveled and extend into corresponding recesses of the adapter element 15′ so that in this way the front end of the sealing element 13′ is prevented from lifting due to the vacuum present during operation relative to the adapter element 15′, and thus relative to the sealing element 12′.

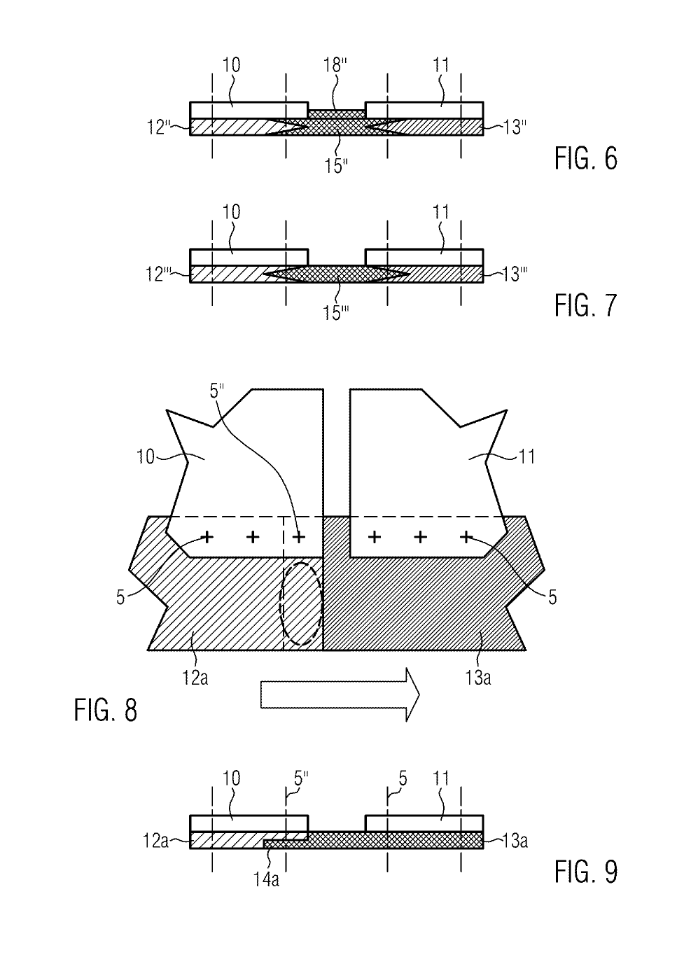

A similar assembly to the one in FIG. 5 is shown in FIG. 6, wherein the ends of the sealing elements 12″ and 13″ are designed the same as in FIG. 5 and engage with corresponding recesses in the adapter element 15″. The adapter element also includes a projection 18″, which extends into the gap between the seal retainer elements 10, 11, while the adapter element 15″ outside these seal retainer elements forms an essentially stepless, continuous surface with the upper surfaces of the sealing elements 12″, 13″.

An adapter element 15″′ with beveled ends is shown in FIG. 7, wherein the beveled ends extend into corresponding recesses in the ends of the sealing elements 12″′ and 13″′ and thus couple these sealing elements to one another via the adapter element, preventing upwards movement.

In the exemplary embodiment of FIGS. 8 and 9, which is configured in accordance with the “overlap concept”, sealing elements 12a and 13a are attached to the still plate-shaped seal retainer elements 10 and 11 via screws 5, and the sealing element 13a at the rear in the direction of flow has a projection 14a on its underside, which extends into a recess on the underside of the rear end of the front sealing element 12 and is attached to the sealing element 12a. The projection 14a can again be attached to the sealing element 12a by means of attachment systems shown in FIG. 11 and disposed in the oval area drawn in broken lines in FIG. 8. However, it is also conceivable to attach the projection 14a to the sealing element 12a with adhesive.

The projection 14a forms a continuous extension of the lower surface of the sealing element 13a with its lower surface and forms a stepless, continuous contact surface with the lower surface of the sealing element 12a. The projection 14a prevents lifting of the front end of the sealing element 13a relative to the rear end of the sealing element 12a during operation.

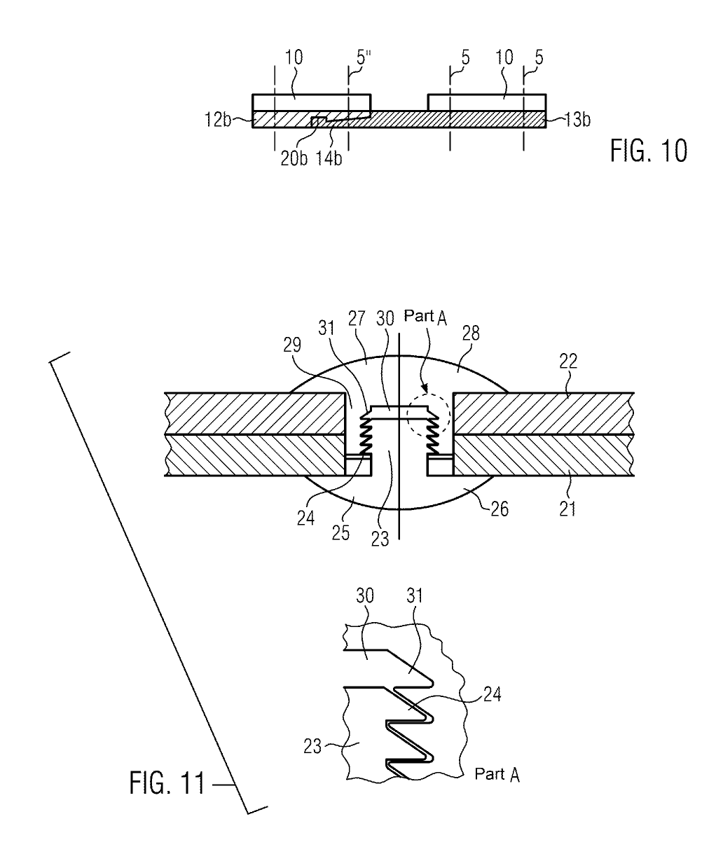

In the further development of the design according to FIGS. 8 and 9 shown in FIG. 10, the rear sealing element 13b has an engagement rib 20b on the projection 14b, which extends into a correspondingly shaped indentation on the underside of the front sealing element 12b and thus additionally strengthens the coupling between the sealing elements 12b and 13b.

FIG. 11 provides a detailed depiction of the attachment system, which, amongst others, in the exemplary embodiments of FIGS. 3 and 4 and of FIGS. 8 and 9, can be employed in the areas identified by ovals.

A lower element 21 and an upper element 22 are attached to one another by means of the attachment system. The lower element may be the projections 16, 17 or the projection 14a, while the upper element is a sealing element 12, 13 or 12a in both exemplary embodiments.

Through-holes, which are aligned with one another, are created in the upper and the lower element 21, 22, and a pin 23 having circumferential radial projections 24 extends into the through-hole from the top surface of the lower element 21, which pin is formed on a first connection element 25, which by means of a head 26 extending laterally over the hole abuts the lower surface of the lower element 21. In addition, a second connection element 27 is provided, which likewise has a head 28 extending laterally over the through-hole, which abuts the upper surface of the upper element 22. A stud 29 is disposed on the second connection element 27, which extends into the through-hole and has a hole 30 having indentations 31 encircling its peripheral surface. Thereby, the pin 23 extends into the hole 30, and the projections 24 engage with the indentations 31, so that the connection elements 25, 27 are firmly connected to one another and the upper and lower elements 21, 22 retain one another. The surfaces of the projections 24 on the pin 23 facing toward the tip of the pin 23 are oblique, while the surfaces facing toward the head extend perpendicular to the longitudinal axis of the pin 23 (see portion A in FIG. 11). As a result, the pin 23 can be inserted into the hole 30, but cannot be retracted from it.

In this way, the projections 16, 17 of the adapter element 15 can be easily connected to the sealing elements 12, 13 in the exemplary embodiment of FIGS. 4 and 5. With the described attachment system in the exemplary embodiment of FIGS. 9 and 10, the projection 14a can likewise be attached to the sealing element 12a.

It should be evident from the above description of the exemplary embodiments that the sealing assembly according to the invention is not limited to an application in the area where the wings connect to the fuselage, but can also be employed in other locations on the aircraft.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A sealing assembly on the exterior of an aircraft, comprising:
several sealing elements lying one behind the other in the direction of flight,
contact surfaces of the sealing elements sitting on a bearing surface of the aircraft,
the sealing elements being attached to seal retainer elements,
a rear end of one sealing element lying immediately adjacent to a front end of a subsequent sealing element located further back on the aircraft in the direction of flight,
adjacent sealing elements forming a lower contact surface and an essentially continuous top surface, interrupted by a gap between them,
the front end of a given sealing element, located further to the rear of the several sealing elements, being configured and arranged so that it is mechanically coupled to the rear end of a sealing element lying in front of the given sealing element such that the gap lying between them is bridged and the front end of the given sealing element located further to the rear is prevented from lifting relative to the rear end of the sealing element lying in front of the given sealing element.

2. The sealing assembly according to claim 1, wherein an adapter element is disposed in the gap between the adjacent sealing elements, the adapter element being attached to the seal retainer elements, and engaging with both sealing elements and which forms, together with the undersides of the sealing elements, a contact surface.

3. The sealing assembly according to claim 2, wherein the upper surface of the adapter element forms, with the upper surfaces of the adjacent sealing elements, a continuous, essentially stepless top surface.

4. The sealing assembly according to claim 2, wherein the adapter element extends by means of projections under both sealing elements.

5. The sealing assembly according to claim 4, wherein the ends of the sealing elements adjoining the adapter element are beveled and extend into correspondingly configured recesses in the adapter element.

6. The sealing assembly according to claim 2, wherein the adapter element has angled ends, which extend into correspondingly shaped recesses in the ends of the sealing elements.

7. The sealing assembly according to claim 2, wherein the support element includes, in the area of the seal retainer elements, a projection extending between the seal retainer elements.

8. The sealing assembly according to claim 1, wherein the front end of the sealing element located further to the rear includes a projection overlapping the underside of the rear end of the front sealing element, which projection extends into a recess on the underside of the front sealing element, so that a stepless contact surface is formed.

9. The sealing assembly according to claim 8, wherein the front end of the projection is designed with an engagement rib, which extends into a correspondingly shaped indentation in the front sealing element.
